(19) United States
(12) Patent Application Publication
(10) Pub. No.: US 2004/0231106 A1
(43) Pub. Date: Nov. 25, 2004

(54) Gate hinge

(76) Inventor: Paul B. Shire, Trenton (CA)

Correspondence Address: Ralph A. Dowell, Suite 309, 1215 Jefferson Davis Hwy, Arlington, VA, 22202-3124, US

(21) Appl. No.: 10/440,249

(22) Filed: May 19, 2003

(51) Int. Cl. E05D 5/06

(52) U.S. Cl. 16/390

(57) ABSTRACT

A butt hinge having a pair of hingedly interconnected hinge arms for mounting a gate to a post in which each of the hinge arms is substantially U-shaped so that each arm can be secured to three faces of the gate or post lumber.

### FIELD OF INVENTION

This invention relates to gate hardware and more particularly to a gate hinge.

### BACKGROUND OF INVENTION AND PRIOR ART

Gate hinges are, of course, well known in the art, and numerous designs have been developed over the past two hundred years or more. Most such hinges include a pair of planar hinge leaves pivotally interconnected by a pin securing them together. Various modifications have been suggested to facilitate securing to either very thick or very thin gate members and attention is directed particularly to U.S. Pat. No. 655,596 of 7 Aug. 1900 and U.S. Pat. No. 5,454,144 of 3 Oct. 1995 as examples of such modifications. Because such hinges are only secured to one face of the gate and/or gatepost, there is a tendency for the gate to sag over time as the securing screw holes become enlarged. There remains, therefore, a need for an improved hinge which will substantially eliminate sagging of even a very large gate.

### OBJECT OF INVENTION

An object of the present invention is to provide an improved gate hinge which may be secured to three faces of a gate or associated post so as to substantially eliminate sagging of the gate.

### BRIEF STATEMENT OF INVENTION

By one aspect of the present invention there is provided a butt hinge for mounting a gate on a gatepost, said hinge comprising:

a) a pair of hinge arms each having a generally U-shaped configuration to embrace a selected one of said gate and gatepost and defined by first and second planar side webs to overlie opposed surfaces of said selected gate and gatepost, respectively and a central planar connection web joining said first and second side webs;

b) complementary knuckle means along one side edge of each of said central connection webs; and

c) pin means insertable in said complementary knuckle means so as to hingedly interconnect said pair of hinge arms.

### BRIEF DESCRIPTION OF DRAWINGS

FIG. 1 is an isometric view of one embodiment of the present invention, showing a straight butt hinge;

FIG. 2 is a bottom plan view of the embodiment of FIG. 1; and

FIG. 3 is an isometric view of an alternative embodiment of the present invention showing a rising butt hinge.

### DETAILED DESCRIPTION OF PREFERRED EMBODIMENTS

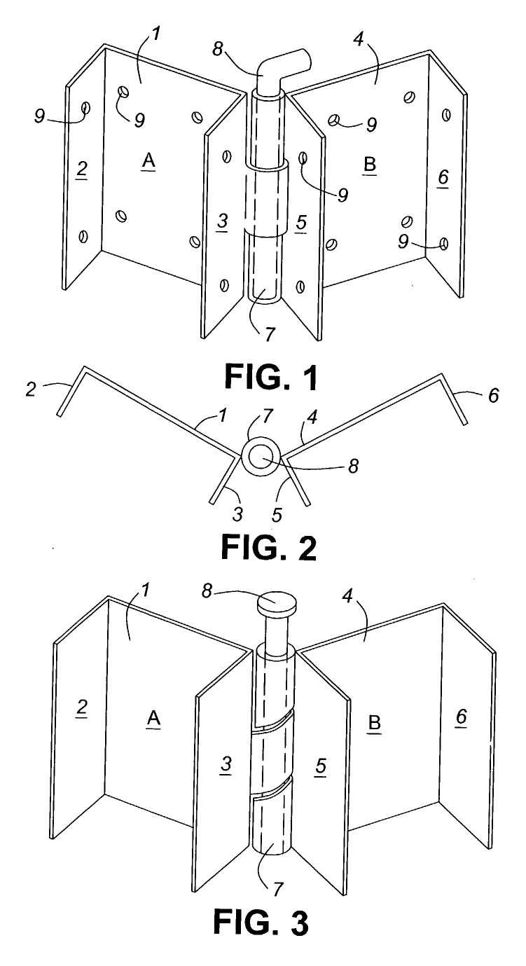

In FIGS. 1 and 2 there is shown a straight butt hinge according to one embodiment of the present invention. A pair of substantially U-shaped hinge arms A and B, comprising planar side webs 2,3 and 5,6 respectively interconnected by respective planar central connection webs 1 and 4, are hingedly interconnected by means of complementary hollow knuckles 7 secured along one side edge of each of central connection webs 1,4 adjacent side webs 3 and 5 respectively. Generally, but not essentially, all of the webs are fabricated in steel or other metal, such as brass or bronze, and the knuckles 7 are secured to webs 1 and 4 by welding or brazing thereto. A pivot pin 8 is inserted into knuckles 7 so as to hingedly interconnect arms A and B. Any selected number of screw holes 9 may be provided in all of the webs to receive appropriate screws or other fastening means (not shown) to secure the hinge to the gate and gatepost on three sides of each piece of lumber. This spreads the load considerably and lends considerable strength to the gate to resist loosening of the screws and to prevent sagging of even relatively heavy gates. Note that the knuckles 7 in FIG. 1 are cut perpendicular to plates 3,5 so as to provide a straight butt hinge in conventional manner. In FIG. 3 there is shown a rising butt hinge, which has the advantage that the gate is substantially self-closing and also rises on opening to clear obstructions, in which the knuckles are cut at 45° to plates 3,5.

It will be appreciated that the hinge of the present invention may be made in many different sizes so as to accommodate different sized framing and gate lumber. When building fences and gates in use in residential areas, 2″×4″ or 4″×4″ lumber is frequently employed and the hinge may conveniently be made to accommodate both these sizes. Larger sizes may be required for farm or agricultural use. It will also be appreciated that, while this invention has been described with reference to a hinged gate, it is equally applicable for use in a fence with a removable section. A hinge is simply secured at each end of the removable section and secured to the adjacent fence post. When it is desired to open the fence the pin means 8 are simply withdrawn from knuckles 7 and the fence can then be manually moved out of the way.

I claim:

1. A butt hinge for mounting a gate on a gatepost, said hinge comprising:
a) a pair of hinge arms each having a generally U-shaped configuration to embrace a selected one of said gate and gatepost and defined by first and second planar side webs to overlie opposed surfaces of said selected gate and gatepost, respectively and a central planar connection web joining said first and second side webs;
b) complementary knuckle means along one side edge of each of said central connection webs; and
c) pin means insertable in said complementary knuckle means so as to hingedly interconnect said pair of hinge arms.

2. A hinge as claimed in claim 1 wherein said first and second side webs are each substantially perpendicular to said central connection web.

3. A hinge as claimed in claim 2 wherein said pin means is a slidably removable pin means.

4. A hinge as claimed in claim 3 wherein said hinge is a straight butt hinge.

5. A hinge as claimed in claim 3 wherein said hinge is a rising butt hinge.
